(19) United States
(12) Patent Application Publication
(10) Pub. No.: US 2016/0087303 A1
(43) Pub. Date: Mar. 24, 2016

(54) LAMINATED CELL PREPARATION DEVICE

(71) Applicants: DONGGUAN AMPEREX TECHNOLOGY LIMITED, Dongguan (CN); NINGDE AMPEREX TECHNOLOGY LIMITED, Ningde (CN)

(72) Inventors: Jingbin LIN, Dongguan (CN); Baoan JIA, Dongguan (CN); Yanming LIANG, Dongguan (CN); Xianrui CHEN, Dongguan (CN); Huaiyong ZHANG, Dongguan (CN); Qiuyan LIU, Dongguan (CN)

(21) Appl. No.: 14/852,187

(22) Filed: Sep. 11, 2015

(30) Foreign Application Priority Data
Sep. 23, 2014 (CN) 201410491777.2

(51) Int. Cl. H01M 10/04; B32B 38/18; B32B 41/00; B32B 37/10; B32B 38/00; H01M 10/0525; B32B 37/18

(52) U.S. Cl. CPC H01M 10/0404; H01M 10/0525; B32B 38/1808; B32B 37/18; B32B 37/10; B32B 38/0004; B32B 41/00; B32B 2041/04; B32B 2457/10

(57) ABSTRACT

The present disclosure provides a laminated cell preparation device comprising: a lamination platform; an anode plate preparation mechanism for positioning and preparing an anode plate one piece by one piece; a cathode plate preparation mechanism for positioning and preparing a cathode plate one piece by one piece; a separator providing mechanism for positioning a separator and providing the separator directly to the lamination platform; an anode plate manipulator for picking the each prepared anode plate from the anode plate preparation mechanism one piece by one piece and providing the each anode plate directly to the lamination platform; a cathode plate manipulator for picking the each prepared cathode plate from the cathode plate preparation mechanism one piece by one piece and providing the each cathode plate directly to the lamination platform; the anode plate, the separator, and the cathode plate are laminated without positioning, so as to form a laminated cell.

### CROSS-REFERENCE TO RELATED APPLICATIONS

The present application claims priority to Chinese Patent Application No. CN201410491777.2 filed on Sep. 23, 2014, which is incorporated herein by reference in its entirety.

### TECHNICAL FIELD OF THE PRESENT DISCLOSURE

The present disclosure relates to the field of energy storage devices, and particularly relates to a laminated cell preparation device.

### BACKGROUND OF THE PRESENT DISCLOSURE

Production processes of a cell of a lithium-ion battery are generally classified into a winding process and a laminating process, and the cell produced by the laminating process has the advantages of high capacity and low internal resistance, and a shape of the cell produced by the laminating process is varied, which can be designed according to actual requirements.

Based on difference in separators which are used, the laminating process can be divided into two kinds: 1) an ordinary laminating process that a band-shaped anode plate, a band-shaped separator and a band-shaped cathode plate each are cut to form a corresponding plate with a required plate-shape by using a plate preparation machine (that is plate preparation), then the formed anode plate , the formed separator plate and the formed cathode plate are laminated in order on a plate laminating platform (that is plate lamination), so as to obtain a laminated cell; and 2) a Z-shaped laminating process that a band-shaped anode plate and a band-shaped cathode plate each are cut to form a corresponding plate with a required plate-shape by using a plate preparation machine (that is plate preparation), then the formed anode plate and the formed cathode plate are alternately disposed into a Z-shaped separator on a plate laminating platform (that is plate lamination), so as to obtain a laminated cell.

In the above two kinds of laminating processes, the plate preparation process and the laminating process are performed respectively at the site of the plate preparation machine and a site of a plate laminating machine, that is, at the site of the plate preparation machine, a band-shaped material (the band-shaped anode plate, the band-shaped cathode plate and/or the band-shaped separator) to be cut is required to be positioned (that is a first positioning, which can be realized by an unwinding/feed deviation rectification sensor) and to be cut, then a plurality of cut plate-shaped materials are put into a collection box, next the collection box is transported to a predetermined position of the plate laminating machine for the collection box and is fixed, and then the plurality of plate-shaped materials (the plate-shaped anode plate, the plate-shaped cathode plate or the plate-shaped separator) in the collection box are grasped out (or are sucked out by a sucker) one piece by one piece and are positioned again (that is a second positioning, which can be performed by grasping or sucking to the plate laminating platform), finally, the positioned anode plate, the positioned separator and the positioned cathode plate are laminated in order to prepare the laminated cell on the plate laminating platform.

Therefore, in the above two kinds of laminating processes, because the plate preparation process and the laminating process use two independent devices which are not associated with each other, the each material to be laminated is required to be positioned at least twice (that is, the positioning in the plate preparation process and the positioning in the plate laminating process). In addition, the auxiliary time between the plate preparation process and the laminating process is long (that is the time that the cut material is put into the collection box and the time that the collection box is transported to the predetermined position of the plate laminating machine for the collection box), the production efficiency is low, and the material to be laminated (for the anode plate and the cathode plate) is transferred many times, the active materials of the electrode plates are liable to strip off and edge and corner of the electrode plates are liable to be damaged in the transferring process.

### SUMMARY OF THE PRESENT DISCLOSURE

In view of the problems existing in the background, an object of the present disclosure is to provide a laminated cell preparation device, which can improve the production efficiency of the laminated cell.

Another object of the present disclosure is to provide a laminated cell preparation device, which can improve the yield rate of production of the laminated cell.

In order to achieve the above objects, the present disclosure provides a laminated cell preparation device, which comprises: a lamination platform; an anode plate preparation mechanism for positioning and preparing an anode plate one piece by one piece; a cathode plate preparation mechanism for positioning and preparing a cathode plate one piece by one piece; a separator providing mechanism for positioning a separator and providing the separator directly to the lamination platform; an anode plate manipulator for picking the each prepared anode plate from the anode plate preparation mechanism one piece by one piece and providing the each anode plate directly to the lamination platform; a cathode plate manipulator for picking the each prepared cathode plate from the cathode plate preparation mechanism one piece by one piece and providing the each cathode plate directly to the lamination platform; the anode plate, the separator, and the cathode plate are laminated on the lamination platform in such a way that the separator is between the anode plate and the cathode plate and are laminated without positioning, so as to form a laminated cell.

The present disclosure has the following beneficial effects:

1. Both the plate preparing process and the plate laminating process of the laminated cell are integrated into the same device (i.e. the laminated cell preparation device), positioning is only performed in the plate preparing process, then the laminating process is directly performed on the prepared material (the anode plate, the cathode plate or the separator) which has been positioned, so that the step of secondary-positioning in the plate lamination in the traditional laminating process is omitted, thereby simplifying the production process and improving the production efficiency.

2. The auxiliary time between the plate preparing process and the laminating process of the laminated cell is omitted, that is the step of putting the cut material (the anode plate, the cathode plate or the separator) into the collection box in the traditional laminating process and the step of transporting the collection box to the predetermined position of the plate laminating machine for the collection box are omitted, thereby saving the time cost, and improving the production efficiency.

3. The material to be laminated (the anode plate, the cathode plate or the separator) is directly provided to the lamination platform after preparation, so that a plurality of transferring steps including putting the cut material to be laminated into the collection box, the positioning platform, the plate laminating platform sequentially in the traditional laminating process are omitted, the transferring processes of the anode plate and the cathode plate are simplified in the production process, the collection box is omitted, phenomena, such as stripping-off of the active material of the electrode plate, and bending of the electrode plates, and contact-damaging of edge and corner of the electrode plates which are liable to occur in the transferring process, are reduced, thereby improving the yield rate of production of the laminated cell.

4. A plurality of cut materials (the anode plate, the cathode plate or the separator) are put into the collection box used in the traditional laminating process, therefore, picking a plurality of pieces of the cut materials is liable to occur in the subsequent picking (grapping or sucking) step, but in the laminated cell preparation device according to the present disclosure, once one piece of the material is prepared and the one piece of the material is picked and provided to the lamination platform, so that the above problem is avoided.

5. In the laminated cell preparation device according to the present disclosure, once one piece of the material (the anode plate, the cathode plate or the separator) is prepared and then the one piece of the material is picked (grasped or sucked) and provided to the lamination platform and is laminated, thereby facilitating efficient and orderly production when a preparation speed, a picking speed and a lamination speed are coordinated.

### BRIEF DESCRIPTION OF THE FIGURES

FIG. 1 is a structural schematic view of an embodiment of a laminated cell preparation device according to the present disclosure;

FIG. 2 is a schematic view of a laminated cell preparation process performed by the laminated cell preparation device of FIG. 1;

FIG. 3 is a schematic view of a laminated cell preparation process of another embodiment of the laminated cell preparation device of FIG. 1;

FIG. 4 is a structural schematic view of an embodiment of the laminated cell preparation device according to the present disclosure;

FIG. 5 is a structural schematic view of an embodiment of the laminated cell preparation device according to the present disclosure.

Reference numerals of the embodiments are represented as follows:
1 lamination platform
2 anode plate preparation mechanism

21 anode plate unwinding mechanism

22 anode plate feed drive mechanism

23 anode plate cutting mechanism

24 anode plate deviation rectification mechanism

26 anode plate tension control mechanism
P anode plate
3 cathode plate preparation mechanism

31 cathode plate unwinding mechanism

32 cathode plate feed drive mechanism

33 cathode plate cutting mechanism

34 cathode plate deviation rectification mechanism

36 cathode plate tension control mechanism
N cathode plate
4 separator providing mechanism

41 separator preparation mechanism
411 separator unwinding mechanism
412 separator feed drive mechanism
413 separator cutting mechanism
414 separator deviation rectification mechanism
415 separator tension control mechanism
416 guide-roller pair

42 separator manipulator

43 support roller

44 separator deviation rectification sensor

A₁ first lamination position

A₂ second lamination position
S separator
5 anode plate manipulator
6 cathode plate manipulator
7 hot-press mechanism

### DETAILED DESCRIPTION

Hereinafter a laminated cell preparation device according to the present disclosure will be described in detail in combination with the Figures.

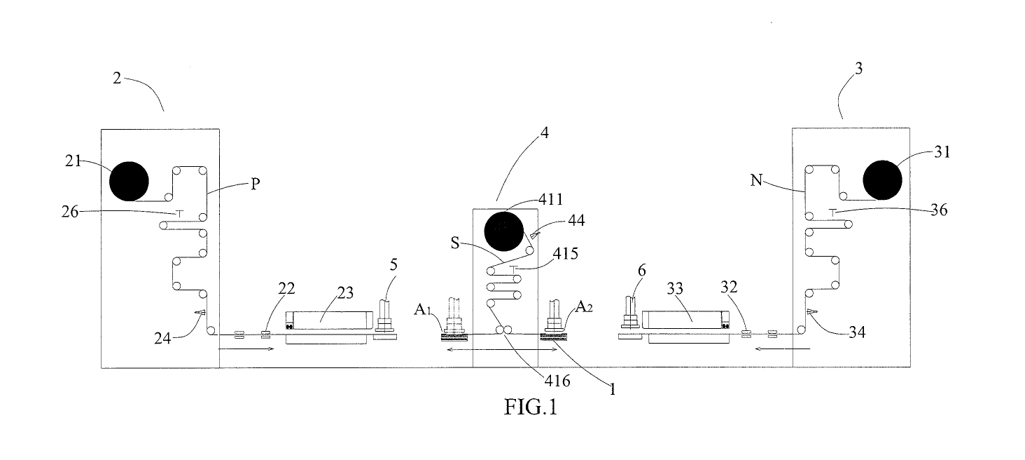

Referring to FIGS. 1-5, a laminated cell preparation device according to the present disclosure comprises: a lamination platform 1; an anode plate preparation mechanism 2 for positioning and preparing an anode plate P one piece by one piece; a cathode plate preparation mechanism 3 for positioning and preparing a cathode plate N one piece by one piece; a separator providing mechanism 4 for positioning a separator S and providing the separator S directly (without the collection box in the laminating process of background technology and without being positioned again) to the lamination platform 1; an anode plate manipulator 5 for picking the each prepared anode plate P from the anode plate preparation mechanism 2 one piece by one piece and providing the each anode plate P directly (without the collection box in the laminating process of background technology and without being positioned again) to the lamination platform 1; a cathode plate manipulator 6 for picking the each prepared cathode plate N from the cathode plate preparation mechanism 3 one piece by one piece and providing the each cathode plate N directly (without the collection box in the laminating process of background technology and without being positioned again) to the lamination platform 1; the anode plate P, the separator S, and the cathode plate N are laminated on the lamination platform 1 in such a way that the separator S is between the anode plate P and the cathode plate N and being laminated without positioning, so as to form a laminated cell.

Compared with the prior art, the laminated cell preparation device of the present disclosure has the following beneficial effects:

1. Both the plate preparing process and the plate laminating process of the laminated cell are integrated into the same device (i.e. the laminated cell preparation device), positioning is only performed in the plate preparing process, then the laminating process is directly performed on the prepared material (the anode plate P, the cathode plate N or the separator S) which has been positioned, so that the step of secondary-positioning in the plate lamination in the traditional laminating process is omitted, thereby simplifying the production process and improving the production efficiency.

2. The auxiliary time between the plate preparing process and the laminating process of the laminated cell is omitted, that is the step of putting the cut material (the anode plate P, the cathode plate N or the separator S) into the collection box in the traditional laminating process and the step of transporting the collection box to the predetermined position of the plate laminating machine for the collection box are omitted, thereby saving the time cost, and improving the production efficiency.

3. The material to be laminated (the anode plate P, the cathode plate N or the separator S) is directly provided to the lamination platform 1 after preparation, so that a plurality of transferring steps including putting the cut material to be laminated into the collection box, the positioning platform, the plate laminating platform sequentially in the traditional laminating process are omitted, the transferring processes of the anode plate P and the cathode plate N are simplified in the production process, the collection box is omitted, phenomena, such as stripping-off of the active materials of the electrode plate, and bending of the electrode plates, and contact-damaging of edge and corner of the electrode plates which are liable to occur in the transferring process, are reduced, thereby improving the yield rate of production of the laminated cell.

4. A plurality of cut materials (the anode plate P, the cathode plate N or the separator S) are put into the collection box used in the traditional laminating process, therefore, picking a plurality of pieces of the cut materials is liable to occur in the subsequent picking (grapping or sucking) step, but in the laminated cell preparation device according to the present disclosure , once one piece of the material is prepared and the one piece of the material is picked and provided to the lamination platform 1, so that the above problem is avoided.

5. In the laminated cell preparation device according to the present disclosure, once one piece of the material (the anode plate P, the cathode plate N or the separator S) is prepared and then the one piece of the material is picked (grasped or sucked) and provided to the lamination platform 1 and is laminated, thereby facilitating efficient and orderly production when a preparation speed, a picking speed and a lamination speed are coordinated.

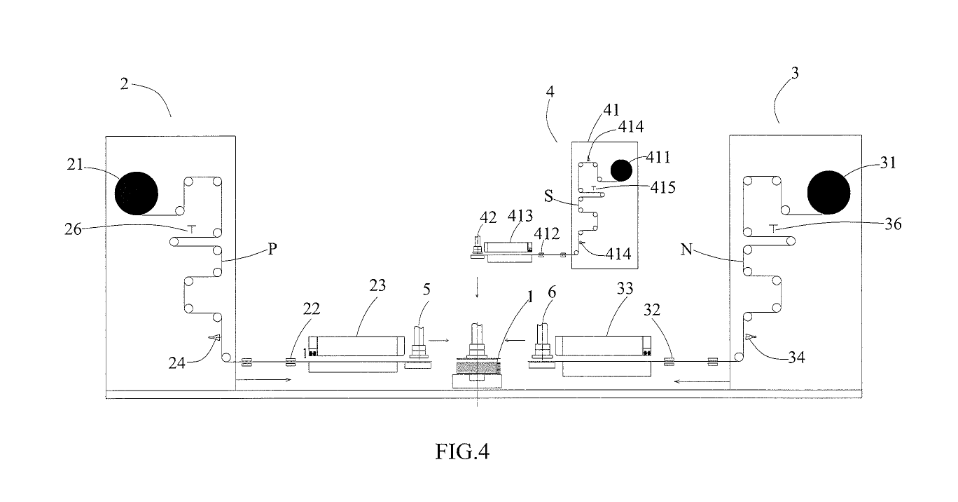

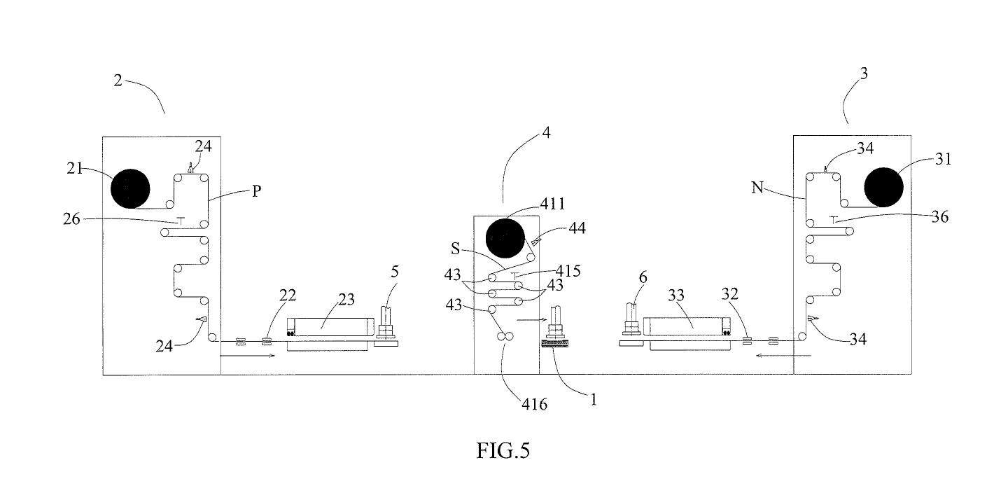

In an embodiment of the anode plate preparation mechanism 2, referring to FIG. 1, FIG. 4 and FIG. 5, the anode plate preparation mechanism 2 may comprise: an anode plate unwinding mechanism 21 providing and outputting a band-shaped anode plate P to be cut; an anode plate feed drive mechanism 22 provided to the downstream of the anode plate unwinding mechanism 21 and providing a driving force for transferring the band-shaped anode plate P; an anode plate cutting mechanism 23 provided to the downstream of the anode plate feed drive mechanism 22 for cutting the transferred band-shaped anode plate P, so as to form the anode plate P one piece by one piece; and at least an anode plate deviation rectification mechanism 24 provided to the upstream of the anode plate cutting mechanism 23 for positioning the band-shaped anode plate P to be cut; the anode plate manipulator 5 directly picks the anode plate P formed by cutting of the anode plate cutting mechanism 23 from the anode plate cutting mechanism 23.

In an embodiment of the anode plate preparation mechanism 2, referring to FIG. 5, the anode plate deviation rectification mechanism 24 may be provided as two in number, which are respectively provided to the upstream of the anode plate cutting mechanism 23 and the downstream of the anode plate unwinding mechanism 21.

In an embodiment of the anode plate preparation mechanism 2, referring to FIG. 1, FIG. 4 and FIG. 5, the anode plate preparation mechanism 2 may further comprise: an anode plate tension control mechanism 26 provided between the anode plate unwinding mechanism 21 and the anode plate feed drive mechanism 22 for adjusting the tension of the transferred band-shaped anode plate P.

In an embodiment of the cathode plate preparation mechanism 3, referring to FIG. 1, FIG. 4 and FIG. 5, the cathode plate preparation mechanism 3 may comprise: a cathode plate unwinding mechanism 31 providing and outputting a band-shaped cathode plate N to be cut; a cathode plate feed drive mechanism 32 provided to the downstream of the cathode plate unwinding mechanism 31 and providing a driving force for transferring the band-shaped cathode plate N; a cathode plate cutting mechanism 33 provided to the downstream of the cathode plate feed drive mechanism 32 for cutting the transferred band-shaped cathode plate N so as to form the cathode plate N one piece by one piece; and at least a cathode plate deviation rectification mechanism 34 provided to the upstream of the cathode plate cutting mechanism 33 for positioning the band-shaped cathode plate N to be cut; the cathode plate manipulator 6 directly picks the cathode plate N formed by cutting of the cathode plate cutting mechanism 33 from the cathode plate cutting mechanism 33.

In an embodiment of the cathode plate preparation mechanism 3, referring to FIG. 5, the cathode plate deviation rectification mechanism 34 may be provided as two in number, which are respectively provided to the upstream of the cathode plate cutting mechanism 33 and the downstream of the cathode plate unwinding mechanism 31.

In an embodiment of cathode plate preparation mechanism 3, referring to FIG. 1, FIG. 4 and FIG. 5, the cathode plate preparation mechanism 3 may further comprise: a cathode plate tension control mechanism 36 provided between the cathode plate unwinding mechanism 31 and the cathode plate feed drive mechanism 32 for adjusting the tension of the transferred band-shaped cathode plate N.

In an embodiment of the separator providing mechanism 4, referring to FIG. 4, the separator providing mechanism 4 may comprise: a separator preparation mechanism 41 for preparing the separator S one piece by one piece; and a separator manipulator 42 for directly picking the each prepared separator S from the separator preparation mechanism 41 and providing the each prepared separator S to the lamination platform 1; the anode plate manipulator 5 picks one piece of prepared anode plate P from the anode plate preparation mechanism 2 and puts the one piece of anode plate P on the lamination platform 1, the separator manipulator 42 directly picks one piece of prepared separator S from the separator preparation mechanism 41 and puts the one piece of separator S on the lamination platform 1, and the cathode plate manipulator 6 picks one piece of prepared cathode plate N from the cathode plate preparation mechanism 3 and puts the one piece of cathode plate N on the lamination platform 1, so that the anode plate P, the separator S and the cathode plate N are laminated alternately on the lamination platform 1 in order.

In an embodiment of the separator preparation mechanism 41, referring to FIG. 4, the separator preparation mechanism 41 may comprise: a separator unwinding mechanism 411 providing and outputting a band-shaped separator S to be cut; a separator feed drive mechanism 412 provided to the downstream of the separator unwinding mechanism 411 and providing a driving force for transferring the band-shaped separator S; a separator cutting mechanism 413 provided to the downstream of the separator feed drive mechanism 412 for cutting the transferred band-shaped separator S, so as to prepare the separator S one piece by one piece; and at least a separator deviation rectification mechanism 414 provided to the upstream of the separator cutting mechanism 413 for positioning the band-shaped separator S to be cut; the separator manipulator 42 directly picks the each prepared separator S formed by cutting of the separator cutting mechanism 413 from the separator cutting mechanism 413.

In an embodiment of the separator preparation mechanism 41, referring to FIG. 4, the separator deviation rectification mechanism 414 may be provided as two in number, which are respectively provided to the upstream of the separator cutting mechanism 413 and the downstream of the separator unwinding mechanism 411.

In an embodiment of the separator preparation mechanism 41, referring to FIG. 4, the separator preparation mechanism 41 may further comprise: a separator tension control mechanism 415 provided between the separator unwinding mechanism 411 and the separator feed drive mechanism 412 for adjusting the tension of the transferred band-shaped separator S.

In an embodiment of the separator providing mechanism 4, referring to FIG. 5, the separator providing mechanism 4 may comprise: a separator unwinding mechanism 411 providing and outputting the separator S; and a support roller 43 guiding the separator S output from the separator unwinding mechanism 411 and supporting the separator S to form a Z-shape; the anode plate manipulator 5 directly picks one piece of prepared anode plate P from the anode plate preparation mechanism 2 and inserts into a corresponding part of the Z-shaped separator S, and the cathode plate manipulator 6 directly picks one piece of prepared cathode plate N from the cathode plate preparation mechanism 3 and inserts into a corresponding part of the Z-shaped separator S, so that the anode plate P and the cathode plate N are laminated alternately in the Z-shaped separator S, the support roller 43 is pulled out after completion of laminating, a laminated body formed by the anode plate P, the cathode plate N and the separator S are put on the lamination platform 1. Putting the laminated body on the lamination platform 1 may be realized by picking of another manipulator (not shown), and may also be realized by that the lamination platform 1 is located directly beneath the laminated body and the laminated body falls off onto the lamination platform 1. In an embodiment, the separator providing mechanism 4 further comprises: a separator cutting off mechanism (not shown) cutting off the separator S after completion of laminating. Here, it should be noted that, because the separator S may be in continuous unwinding in actual production, therefore, in this case, the separator S may be cut off at a tail end of the laminated body after completion of one laminated body. Of course it is not limited to that, if a length of the separator S is provided accurately, there is no need for cutting off the separator S at the tail end of the laminated body, and in other words, the length of the separator S just meets the requirement for the one laminated body. In addition, clipping a head end of the separator S is performed by a guide-roller pair 416 in FIG. 5, or operated by another manipulator (not shown), which may be changed flexibly depending on the actual production.

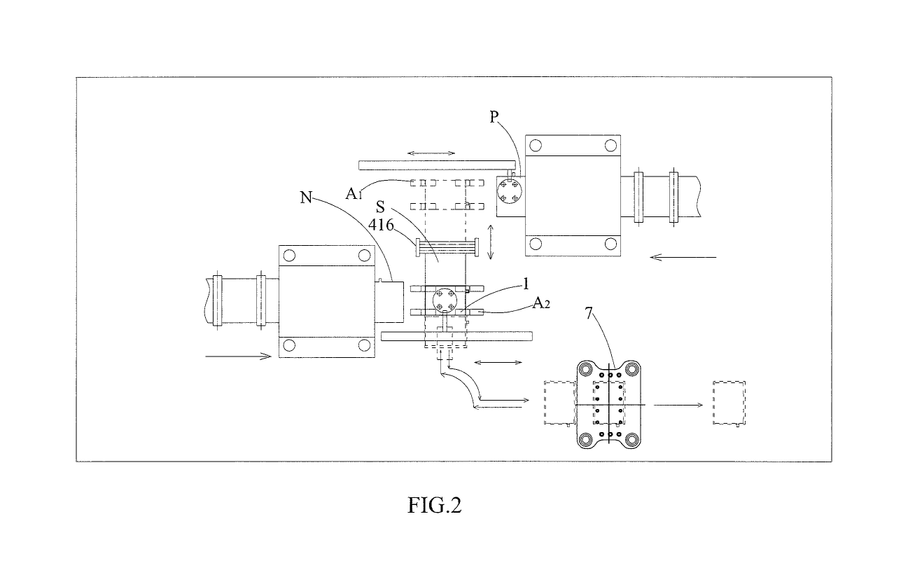

In an embodiment of the separator providing mechanism 4, referring to FIG. 1 and FIG. 2, the separator providing mechanism 4 may comprise: a separator unwinding mechanism 411 providing and outputting the separator S; and a guide-roller pair 416 guiding and clipping the separator S output from the separator unwinding mechanism 411; the guide-roller pair 416 and the lamination platform 1 can make reciprocating movement between a first lamination position A₁ and a second lamination position A₂ relative to each other (a left-right direction in the paper surface of the Figures, and the reciprocating movement can be made by any known drive mechanism), the anode plate manipulator 5 directly picks one piece of prepared anode plate P from the anode plate preparation mechanism 2 and inserts into a corresponding part of the Z-shaped separator S at the first lamination position A₁, the cathode plate manipulator 6 directly picks one piece of prepared cathode plate N from the cathode plate preparation mechanism 3 and inserts into a corresponding part of the Z-shaped separator S at the second lamination position A₂, so that the anode plate P and the cathode plate N are alternately laminated in the Z-shaped separator S on the lamination platform 1. In an embodiment, the lamination platform 1 is fixed and stationary, and the guide-roller pair 416 makes the reciprocating movement relative to the lamination platform 1. A drive mechanism for driving the guide-roller pair 416 to make the reciprocating movement may be any drive mechanism known in the art. In another embodiment, the guide-roller pair 416 is fixed and stationary, and the lamination platform 1 makes the reciprocating movement relative to the guide-roller pair 416. A drive mechanism for driving the lamination platform 1 to make the reciprocating movement may be any drive mechanism known in the art.

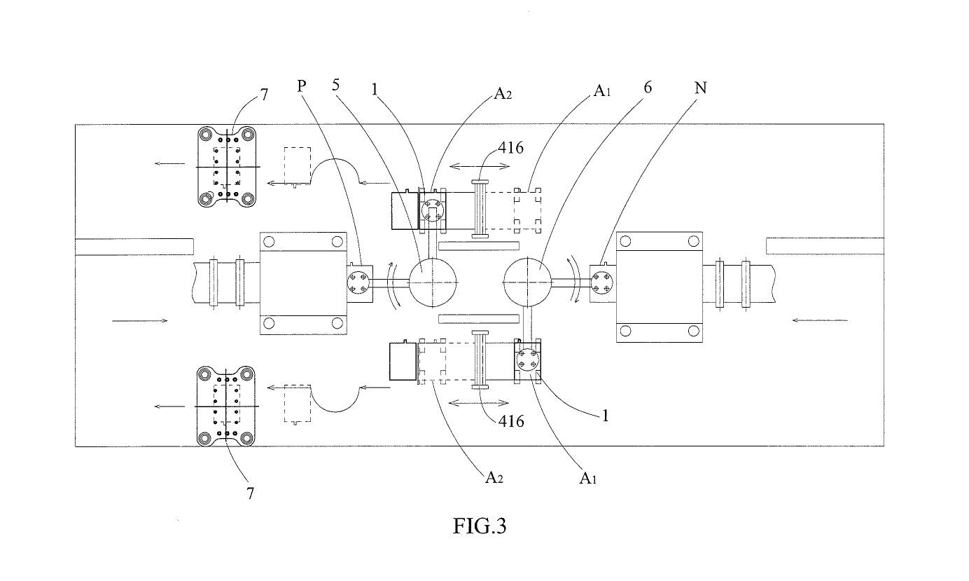

In an embodiment of the laminated cell preparation device according to the present disclosure, the separator unwinding mechanism 411 is provided as two in number, the lamination platform 1 is correspondingly provided as two in number. In the example shown in FIG. 3, the lamination platform 1 at an upper side drives the separator S at the upper side to move as a Z-shaped route (specifically via the guide-roller pair 416 at the upper side), that is, moves back and forth between a first lamination position A₁ at the upper side and a second lamination position A₂ at the upper side; the lamination platform 1 at a lower side drives the separator S at the lower side to move as a Z-shaped route (specifically via the guide-roller pair 416 at the lower side), that is, moves back and forth between a first lamination position A₁ at the lower side and a second lamination position A₂ at the lower side; the lamination platform 1 at the upper side moves to the first lamination position A₁ at the upper side, the lamination platform 1 at the lower side moves to the second lamination position A₂ at the lower side at the same time, at this time, the anode plate manipulator 5 provides the anode plate P to the lamination platform 1 at the upper side, the cathode plate manipulator 6 provides the cathode plate N to the lamination platform 1 at the lower side; next, the lamination platform 1 at the upper side moves to the second lamination position A₂ at the upper side, the lamination platform 1 at the lower side moves to the first lamination position A₁ at the same time, at this time the cathode plate manipulator 6 provides the cathode plate N to the lamination platform 1 at the upper side, the anode plate manipulator 5 provides the anode plate P to the lamination platform 1 at the lower side; the anode plate P and the cathode plate N are laminated alternately like this until a predetermined number of layers is reached. The two lamination platforms 1 perform plate lamination at the same time, which can greatly improve the production efficiency of the laminated cell preparation device.

In an embodiment of the separator providing mechanism 4, referring to FIG. 1 and FIG. 5, the separator providing mechanism 4 may further comprise: a separator deviation rectification sensor 44 provided to the downstream of the separator unwinding mechanism 411 for positioning the transferred separator S.

In an embodiment of the laminated cell preparation device according to the present disclosure, referring to FIG. 2 and FIG. 3, the laminated cell preparation device may further comprise: a hot-press mechanism 7 for hot-pressing the anode plate P, the separator S, and the cathode plate N, which are laminated in order, together.

What is claimed is:

1. A laminated cell preparation device, comprising:
a lamination platform (1);
an anode plate preparation mechanism (2) for positioning and preparing an anode plate (P) one piece by one piece;
a cathode plate preparation mechanism (3) for positioning and preparing a cathode plate (N) one piece by one piece;
a separator providing mechanism (4) for positioning a separator (S) and providing the separator (S) directly to the lamination platform (1);
an anode plate manipulator (5) for picking the each prepared anode plate (P) from the anode plate preparation mechanism (2) one piece by one piece and providing the each anode plate (P) directly to the lamination platform (1);
a cathode plate manipulator (6) for picking the each prepared cathode plate (N) from the cathode plate preparation mechanism (3) one piece by one piece and providing the each cathode plate (N) directly to the lamination platform (1);
the anode plate (P), the separator (S), and the cathode plate (N) being laminated on the lamination platform (1) in such a way that the separator (S) is between the anode plate (P) and the cathode plate (N) and being laminated without positioning, so as to form a laminated cell.

2. The laminated cell preparation device according to claim 1, wherein the anode plate preparation mechanism (2) comprises:
an anode plate unwinding mechanism (21) providing and outputting a band-shaped anode plate (P) to be cut;
an anode plate feed drive mechanism (22) provided to the downstream of the anode plate unwinding mechanism (21) and providing a driving force for transferring the band-shaped anode plate (P);
an anode plate cutting mechanism (23) provided to the downstream of the anode plate feed drive mechanism (22) for cutting the transferred band-shaped anode plate (P), so as to form the anode plate (P) one piece by one piece; and
at least an anode plate deviation rectification mechanism (24) provided to the upstream of the anode plate cutting mechanism (23) for positioning the band-shaped anode plate (P) to be cut;
the anode plate manipulator (5) directly picks the anode plate (P) formed by cutting of the anode plate cutting mechanism (23) from the anode plate cutting mechanism (23).

3. The laminated cell preparation device according to claim 1, wherein the cathode plate preparation mechanism (3) comprises:
a cathode plate unwinding mechanism (31) providing and outputting a band-shaped cathode plate (N) to be cut;
a cathode plate feed drive mechanism (32) provided to the downstream of the cathode plate unwinding mechanism (31) and providing a driving force for transferring the band-shaped cathode plate (N);
a cathode plate cutting mechanism (33) provided to the downstream of the cathode plate feed drive mechanism (32) for cutting the transferred band-shaped cathode plate (N) so as to form the cathode plate (N) one piece by one piece; and
at least a cathode plate deviation rectification mechanism (34) provided to the upstream of the cathode plate cutting mechanism (33) for positioning the band-shaped cathode plate (N) to be cut;
the cathode plate manipulator (6) directly picks the cathode plate (N) formed by cutting of the cathode plate cutting mechanism (33) from the cathode plate cutting mechanism (33).

4. The laminated cell preparation device according to claim 1, wherein the separator providing mechanism (4) comprises:
a separator preparation mechanism (41) for preparing the separator (S) one piece by one piece; and
a separator manipulator (42) for directly picking the each prepared separator (S) from the separator preparation mechanism (41) and providing the each prepared separator (S) to the lamination platform (1);
the anode plate manipulator (5) picks one piece of prepared anode plate (P) from the anode plate preparation mechanism (2) and puts the one piece of anode plate (P) on the lamination platform (1), the separator manipulator (42) directly picks one piece of prepared separator (S) from the separator preparation mechanism (41) and puts the one piece of separator (S) on the lamination platform (1), and the cathode plate manipulator (6) picks one piece of prepared cathode plate (N) from the cathode plate preparation mechanism (3) and puts the one piece of cathode plate (N) on the lamination platform (1), so that the anode plate (P), the separator (S) and the cathode plate (N) are laminated alternately on the lamination platform (1) in order.

5. The laminated cell preparation device according to claim 4, wherein the separator preparation mechanism (41) comprises:
a separator unwinding mechanism (411) providing and outputting a band-shaped separator (S) to be cut;
a separator feed drive mechanism (412) provided to the downstream of the separator unwinding mechanism (411) and providing a driving force for transferring the band-shaped separator (S);
a separator cutting mechanism (413) provided to the downstream of the separator feed drive mechanism (412) for cutting the transferred band-shaped separator (S), so as to prepare the separator (S) one piece by one piece; and
at least a separator deviation rectification mechanism (414) provided to the upstream of the separator cutting mechanism (413) for positioning the band-shaped separator (S) to be cut;
the separator manipulator (42) directly picks the each prepared separator (S) formed by cutting of the separator cutting mechanism (413) from the separator cutting mechanism (413).

6. The laminated cell preparation device according to claim 1, wherein the separator providing mechanism (4) comprises:
a separator unwinding mechanism (411) providing and outputting the separator (S); and
a support roller (43) guiding the separator (S) output from the separator unwinding mechanism (411) and supporting the separator (S) to form a Z-shape;
the anode plate manipulator (5) directly picks one piece of prepared anode plate (P) from the anode plate preparation mechanism (2) and inserts into a corresponding part of the Z-shaped separator (S), and the cathode plate manipulator (6) directly picks one piece of prepared cathode plate (N) from the cathode plate preparation mechanism (3) and inserts into a corresponding part of the Z-shaped separator (S), so that the anode plate (P) and the cathode plate (N) are laminated alternately in the Z-shaped separator (S), the support roller (43) is pulled out after completion of laminating, a laminated body formed by the anode plate (P), the cathode plate (N) and the separator (S) are put on the lamination platform (1).

7. The laminated cell preparation device according to claim 6, wherein the separator providing mechanism (4) further comprises:
a separator cutting off mechanism cutting off the separator (S) after completion of laminating.

8. The laminated cell preparation device according to claim 1, wherein the separator providing mechanism (4) comprises:
a separator unwinding mechanism (411) providing and outputting the separator (S); and
a guide-roller pair (416) guiding and clipping the separator (S) output from the separator unwinding mechanism (411);
the guide-roller pair (416) and the lamination platform (1) can make reciprocating movement between a first lamination position (A₁) and a second lamination position (A₂) relative to each other, the anode plate manipulator (5) directly picks one piece of prepared anode plate (P) from the anode plate preparation mechanism (2) and inserts into a corresponding part of the Z-shaped separator (S) at the first lamination position (Aᵢ), the cathode plate manipulator (6) directly picks one piece of prepared cathode plate (N) from the cathode plate preparation mechanism (3) and inserts into a corresponding part of the Z-shaped separator (S) at the second lamination position (A₂), so that the anode plate (P) and the cathode plate (N) are alternately laminated in the Z-shaped separator (S) on the lamination platform (1) in order.

9. The laminated cell preparation device according to claim 6, wherein the separator providing mechanism (4) further comprises:
a separator deviation rectification sensor (44) provided to the downstream of the separator unwinding mechanism (411) for positioning the transferred separator (S).

10. The laminated cell preparation device according to claim 8, wherein the separator providing mechanism (4) further comprises:
a separator deviation rectification sensor (44) provided to the downstream of the separator unwinding mechanism (411) for positioning the transferred separator (S).

11. The laminated cell preparation device according to claim 1, wherein the laminated cell preparation device further comprises:
a hot-press mechanism (7) for hot-pressing the anode plate (P), the separator (S), and the cathode plate (N), which are laminated in order, together.
